(19) United States
(12) Patent Application Publication
(10) Pub. No.: US 2008/0295163 A1
(43) Pub. Date: Nov. 27, 2008

(54) Method and Apparatus for Updating Anti-Replay Window in Ipsec

(76) Inventor: Song-Min Kang, Seoul (KR)

Correspondence Address: STEIN, MCEWEN & BUI, LLP, 1400 EYE STREET, NW, SUITE 300, WASHINGTON, DC, 20005, US

(21) Appl. No.: 12/092,734

(22) PCT Filed: Nov. 10, 2006
(86) PCT No.: PCT/KR06/04688

§ 371 Date: May 6, 2008

(30) Foreign Application Priority Data
Feb. 9, 2006 (KR) 10-2006-0012588

(51) Int. Cl. G06F 21/00

(52) U.S. Cl. 726/13

(57) ABSTRACT

A method and apparatus for updating an anti-replay window in Internet Protocol Security (IPSec). The method includes determining whether a difference between a sequence number extracted from a received packet and a maximum value of a sequence number of an anti-replay window is greater than a predetermined value; if it is determined that the difference is greater than the predetermined value, creating a first bit map based on a size of the anti-replay window and a second bit map based on the sequence number extracted from the received packet, respectively; comparing the number of bit values in the first bit map of packets received during a predetermined time with the number of bit values in the second bit map of packets received during the predetermined time, and updating the anti-replay window.

### CROSS-REFERENCE TO RELATED APPLICATIONS

This application is a national stage application of PCT International Patent Application No. PCT/KR2006/004688, filed on Nov. 10, 2006, and claims the benefit Korean Patent Application No. 2006-12588, filed in the Korean Intellectual Property Office on Feb. 9, 2006, the disclosures of which are incorporated herein by reference.

### BACKGROUND OF THE INVENTION

1. Field of the Invention

Aspects of the present invention relate to a method and apparatus for updating an anti-replay window in Internet Protocol Security (IPSec), and more particularly, to a method and apparatus for updating an anti-replay window in IPSec according to the reception status of packets, so that hosts on a network can more stably communicate with each other.

2. Description of the Related Art

When two hosts communicate with each other in a network, Internet Protocol Security (IPSec) is used in order to establish a more stable communication environment. The IPSec uses an “anti-replay window” concept in order to prevent a packet replay attack by a third party. Conventionally, an anti-replay window includes a 32-bit map. The conventional method checks a sequence number of a received ESP/AH packet using the 32-bit map, and determines whether the packet is appropriate based on the sequence number and the 32-bit map.

In order to prevent packets received or transmitted between two hosts on a network from being retransmitted by an arbitrary third party when the two hosts communicate with each other, thus preventing communication problems, the anti-replay window method determines whether to finally receive or discard the packets transmitted through the network. However, since an appropriate packet can be discarded according to the range of the anti-replay window, the range of the anti-replay window must be carefully updated.

A packet receiving host receives only packets including sequence numbers within the range of the anti-replay window and discards the remaining packets that are out of range. If a conventional anti-replay window receives a packet having a sequence number greater than a sequence number of a finally received packet, a reference value of the anti-replay window increases unconditionally. In this case, if a packet receiving host receives a packet having a sufficiently greater sequence number arbitrarily transmitted from a third party, a reference value of the anti-replay window increases. As a result, an appropriate packet intended to be received is discarded as the appropriate packet is not within the range of the anti-replay window. Due to an inappropriate packet from a third party, a problem occurs where an appropriate packet transmitted from an actual communicating party is not received.

FIG. 1 is a flowchart of a conventional method of updating an anti-replay window in IPSec. A receiving host receives a packet from a transmitting host in operation S100. The receiving host extracts a sequence number of the received packet in operation S110.

Whether the sequence number of the packet is greater than the maximum value of sequence number of an anti-replay window is determined in operation S120. The maximum value of the sequence number of the anti-replay window represents the maximum value of sequence number of packets received until this point.

If the sequence number of the packet is greater than the maximum value of the sequence number of the anti-replay window, the sequence number of the packet is determined to be the maximum value of sequence number of the anti-replay window, and the anti-replay window is updated in operation S125. If the sequence number of the packet is not greater than the maximum value of the sequence number of the anti-replay window, whether the sequence number of the packet is smaller than a minimum value of the sequence numbers of the anti-replay window is determined in operation S130.

If the sequence number of the packet is smaller than the minimum value of the sequence number of the anti-replay window, the packet is determined to be a retransmission packet and is discarded in operation S135. If the sequence number of the packet is equal to or greater than the minimum value of the sequence number of the anti-replay window, whether a bit value of a bit map for the sequence number of the packet equals “1” is determined in operation S140.

If the bit value of the bit map is “1”, the packet is determined to be a retransmission packet and is discarded in operation S145. If the bit value of the bit map is “0”, the packet is accepted and the bit value of the bit map for the sequence number of the packet changes to “1” in operation S150.

The flowchart shown in FIG. 1 can be expressed as the following table.

TABLE 1

| | | |
|---|---|---|
| Case 1 | If the range of the sequence numbers | accept |
| | of the anti-replay window is satisfied | change the bit |
| | If the corresponding packet is | value of the bit map |
| | received first | of the anti-replay |
| | | window |
| Case 2 | If the range of the sequence numbers | discard |
| | of the anti-replay window is satisfied | |
| | If the corresponding packet is | |
| | received twice or more | |
| Case 3 | if the sequence number of the | discard |
| | received packet is smaller than the | |
| | minimum value of the sequence | |
| | numbers of the anti-replay window | |
| Case 4 | if the sequence number of the | accept |
| | received packet is greater than the | update the anti- |
| | maximum value of the sequence | replay window |
| | number of the anti-replay window | |

FIG. 2 shows an example a method of updating the anti-replay window shown in FIG. 1. A current anti-replay window is composed of a 32-bit map in which the minimum value of sequence number is 39 and the maximum value of the sequence number is 70.

A case where a receiving host receives a packet whose sequence number is 40 will be described. Since the sequence number 40 of the received packet satisfies the range of sequence numbers of the anti-replay window and the corresponding packet is received first, the received packet is accepted, as the received packet corresponds to case 1 of Table 1. The bit value for the sequence number 40 of the anti-replay window changes to “1”.

Then, the receiving host receives a packet whose sequence number is 71. Since the sequence number 71 of the received packet does not satisfy the range of the sequence numbers of the anti-replay window and the sequence number of the received packet is greater than the maximum value of the sequence numbers of the anti-replay window, the received packet is accepted, as the received packet corresponds to the case 4 of Table 1. The sequence number of the received packet is determined to be the maximum value of the sequence number of the anti-replay window, and the anti-replay window is updated. In terms of the updated results of the anti-replay window, the anti-replay window is composed of a 32-bit map in which the minimum value of sequence number of the anti-replay window is 40 and the maximum value of the sequence numbers of the anti-replay window is 71.

Then, the receiving host receives a packet whose sequence number is 35. Since the sequence number 35 of the received packet does not satisfy the range of sequence numbers of the anti-replay window and the sequence number of the receiving packet is smaller than the minimum value of the sequence numbers of the anti-replay window, the received packet is discarded, as the received packet corresponds to case 3 of Table 3.

FIG. 3 shows a problem of the method of updating the anti-replay window as shown in FIG. 1. A current anti-replay window is composed of a 32-bit map in which the minimum value of sequence number of the anti-replay window is 39 and the maximum value of the sequence number is 70.

First, a receiving host receives a packet whose sequence number is 150. Since the sequence number 150 of the received packet does not satisfy the range of sequence numbers of the anti-replay window and the sequence number of the received packet is greater than the maximum value of the sequence number of the anti-replay window, the received packet is accepted, as the received packet corresponds to the case 4 of Table 1. The sequence number of the received packet is determined to be the maximum value of the sequence number of the anti-replay window, and the anti-replay window is updated. In the second case, the anti-replay window is composed of a 32-bit map in which the minimum value of the sequence number of the anti-replay window is 119 and the maximum value of the sequence number is 150.

Then, the receiving host receives packets having sequence numbers 71 through 118. Since the sequence numbers of 71 through 118 do not satisfy the range of sequence numbers of the anti-replay window and the sequence numbers of the received packets are less than the minimum value of the sequence numbers of the anti-replay window, the received packets are discarded, as the received packets correspond to the case 3 of Table 3. As such, a problem exists where the received packets having sequence numbers of 71 through 118 are discarded.

### SUMMARY OF THE INVENTION

Aspects of the present invention provide a method and apparatus for updating an anti-replay window in Internet Protocol Security (IPSec) according to the status of sequence numbers of packets received during a predetermined time using a bit map separately from a timer.

According to an aspect of the present invention, a method of updating an anti-replay window in IPSec (Internet Protocol Security) is provided. The method comprises determining whether a difference between a sequence number extracted from a received packet and a maximum value of a sequence number of an anti-replay window is greater than a predetermined value; if the difference is greater than the predetermined value, creating a first bit map based on a size of the anti-replay window and a second bit map based on the sequence number extracted from the received packet, respectively; and comparing the number of bit values in the first bit map of packets received during a predetermined time with the number of bit values in the second bit map of the packets received during the predetermined time, and updating the anti-replay window based on the result of the comparison.

According to another aspect of the present invention, an apparatus to updating an anti-replay window in IPSec (Internet Protocol Security) is provided. The apparatus comprises a determination unit to determine whether a difference between a sequence number extracted from a received packet and a maximum value of a sequence number of the anti-replay window is greater than a predetermined value; a bit map creating unit to create a first bit map based on a size of the anti-replay window and a second bit map based on the sequence number extracted from the received packet, respectively, if the difference is greater than the predetermined value; and an updating unit to compare the number of bit values in the first bit map of packets received during a predetermined time with the number of bit values in the second bit map of the packets received during a predetermined time, and to update the anti-replay window based on the result of the comparison.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a flowchart of a conventional method of updating an anti-replay window in Internet Protocol Security (IPSec);

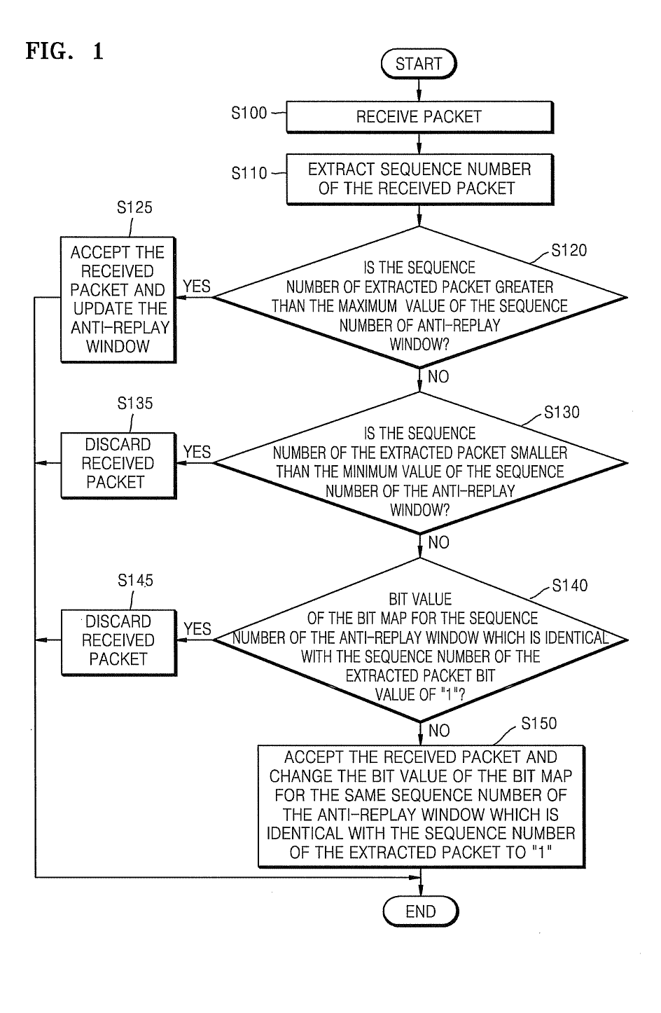

FIG. 2 is a view explaining an example of the conventional method of updating an anti-replay window illustrated in FIG. 1;

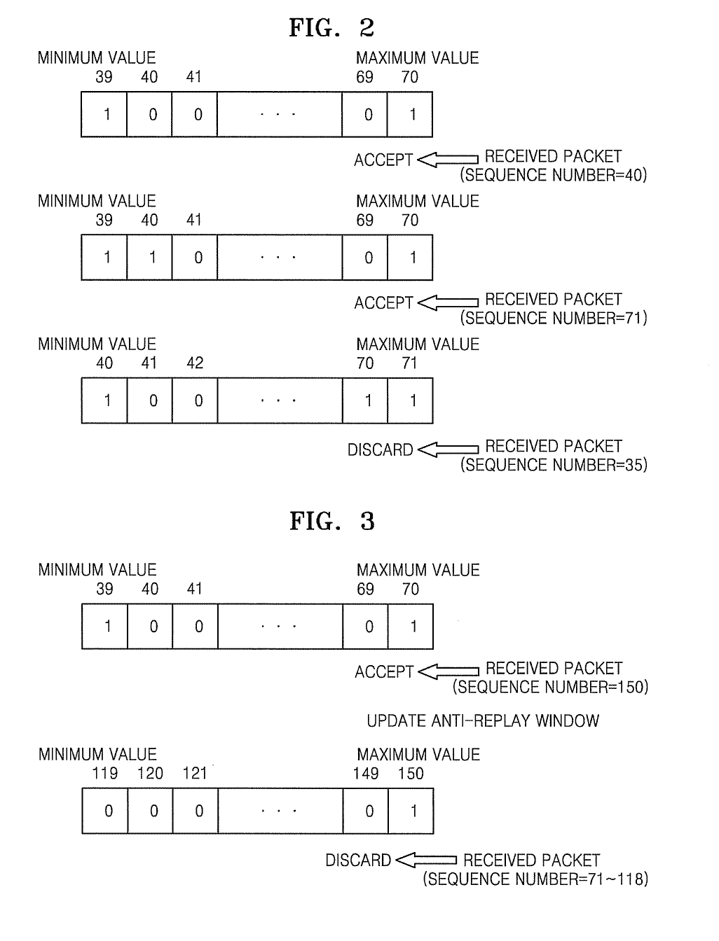

FIG. 3 is an example explaining a problem of the conventional method of updating an anti-replay window illustrated in FIG. 1;

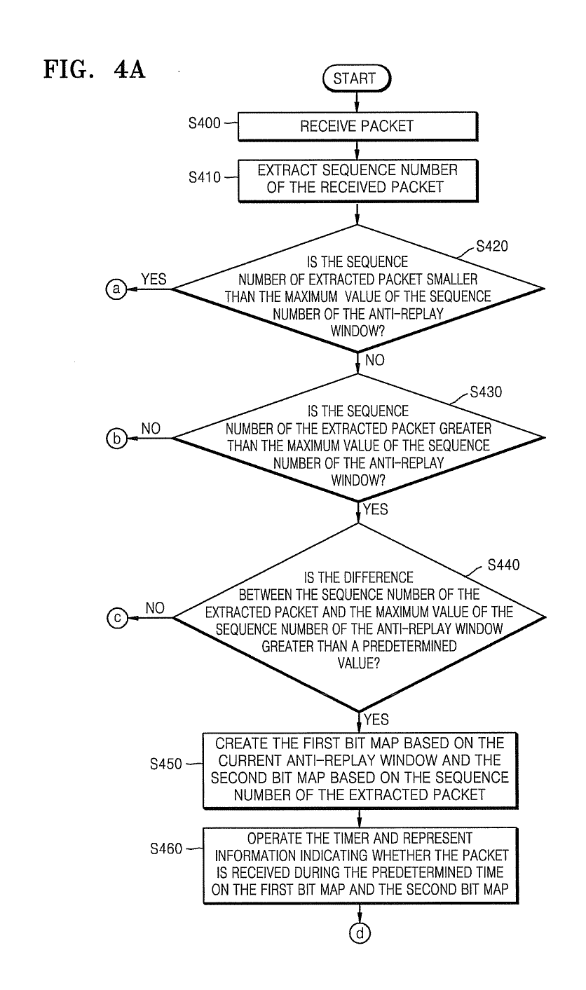

FIGS. 4A and 4B are flowcharts of a process of updating an anti-replay window in IPSec, according to an embodiment of the present invention;

FIG. 5 is a view explaining an example of the process of updating an anti-replay window illustrated in FIG. 4, according to an embodiment of the present invention;

FIG. 6 is a view explaining another example of the process of updating an anti-replay window illustrated in FIG. 4, according to an embodiment of the present invention; and

FIG. 7 is a block diagram of an apparatus for updating an anti-replay window in IPSec, according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

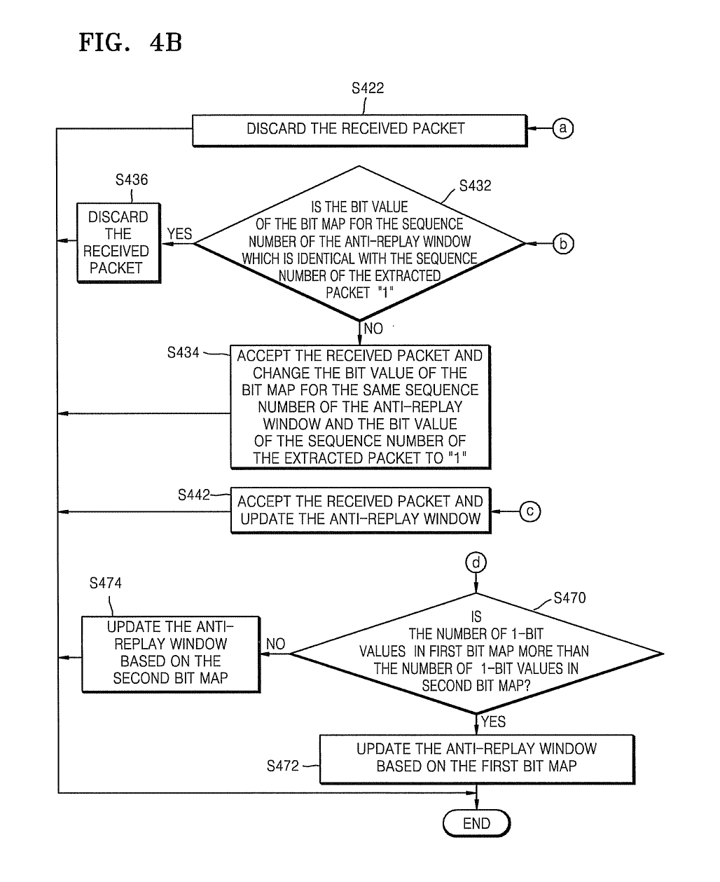

FIGS. 4A and 4B are flowcharts of a process of updating an anti-replay window in Internet Protocol Security (IPSec), according to an embodiment of the present invention. A receiving host receives a packet from a transmitting host in operation S400. The receiving host extracts a sequence number of the packet in operation S410.

Whether the sequence number of the packet is smaller than a minimum value of the sequence number of the anti-replay window is determined in operation S420. The size of the anti-replay window can be set by designating a reference value based on a characteristic of communication between communication hosts, or according to a user's request.

If the sequence number of the packet is smaller than the minimum value of the sequence number of the anti-replay window, the packet is determined to be a retransmitted packet and is discarded in operation S422. If the sequence number of the packet is equal to or greater than the minimum value of the sequence number of the anti-replay window, whether the sequence number of the packet is greater than the maximum value of the sequence number of the anti-replay window is determined in operation S430.

If the sequence number of the packet is equal to or smaller than the maximum value of the sequence number of the anti-replay window, whether a bit value of a bit map for the sequence number of the anti-replay window, which is identical with the sequence number of the packet, is equal to a corresponding bit value of “1” is determined in operation S432.

If the bit value of a bit map for the sequence number of the anti-replay window is equal to “0”, the received packet is accepted and the bit value of the bit map for the corresponding sequence number of the anti-replay window changes to “1” in operation S434. If the bit value of the bit map for the sequence number of the anti-replay window is equal to a corresponding bit value of “1”, the received packet is determined to be a retransmitted packet and is discarded in operation S436.

If the sequence number of the packet is greater than the maximum value of the sequence number of the anti-replay window, whether a difference between the sequence number of the packet and the maximum value of the sequence numbers of the anti-replay window is greater than a predetermined value is determined in operation S440. For example, in operation S440, the predetermined value can be set to a value obtained by subtracting the minimum value of the sequence number of the anti-replay window from the maximum value of the sequence number of the anti-replay window. Further, the predetermined value can be set according to system type. The predetermined value can change by designating a reference value based on a characteristic of communication between communication hosts, or according to a user's request.

If the difference between the sequence number of the packet and the maximum value of the sequence number of the anti-replay window is not greater than the predetermined value, the sequence number of the packet is determined to be the maximum value of the sequence number of the anti-replay window, and the anti-replay window is updated in operation S442. If the difference between the sequence number of the packet and the maximum value of the sequence number of the anti-replay window is greater than the predetermined value, a first bit map based on the size of the current anti-replay window and a second bit map based on the sequence number of the packet are created in operation S450.

The first bit map includes the current anti-replay window and is larger than the maximum value of the sequence number of the current anti-replay window by a predetermined amount. For example, the first bit map may be double the size of the current anti-replay window. The second bit map may have the sequence number of the packet as an intermediate value, and may have the same size as the first bit map.

After operation S450, a timer operates, and information indicating whether a packet is received is displayed during a predetermined time on the first bit map and the second bit map in operation S460. In operation S460, the predetermined time may vary by designating a reference value based on the characteristic of communication between communication hosts, or according to a user's request.

After operation S460, if the operation of the timer is complete, whether the number of 1-bit values in the first bit map is more than the number of 1-bit values in the second bit map is determined in operation S470. If the number of 1-bit values in the first bit map is more than the number of 1-bit values in the second bit map, the anti-replay window is updated based on the first bit map in operation S472. If the number of 1-bit values in the second bit map is more than the number of 1-bit values in the first bit map, the anti-replay window is updated based on the second bit map in operation S474.

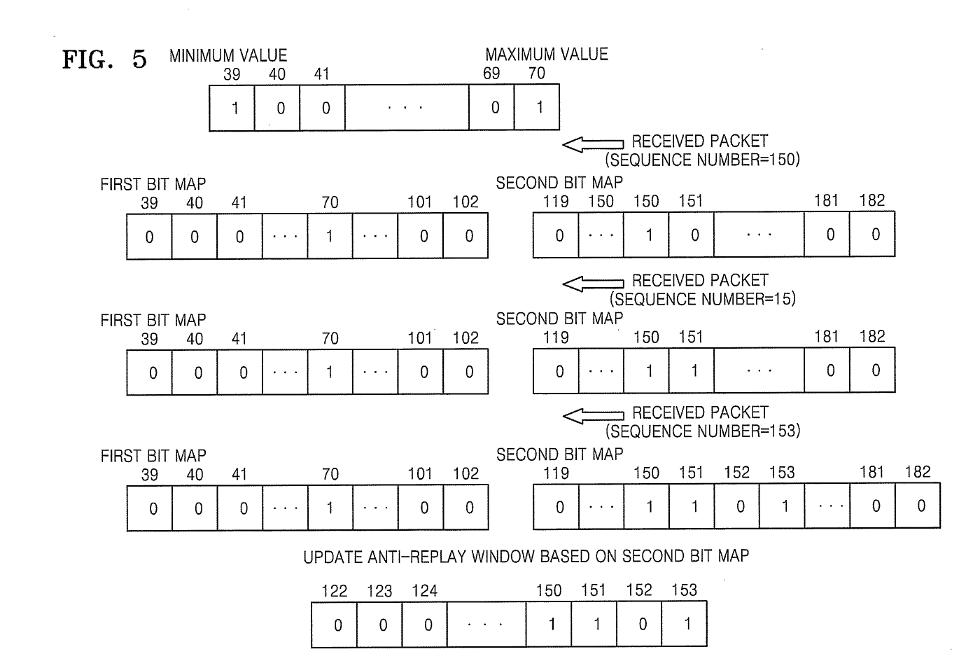

FIG. 5 shows an example of the process of updating an anti-replay window shown in FIGS. 4A and 4B, according to an embodiment of the present invention. The anti-replay window is composed of a 32-bit map in which the minimum value of the sequence number of the current anti-replay window is 39 and the maximum value of the sequence number is 70.

A case where a received packet having a sequence number 150 will be described. The sequence number 150 of the received packet is greater than the maximum value 70 of the sequence number of the anti-replay window, and it is assumed that a difference 80 between the sequence number 150 and the maximum value 70 of the sequence numbers of the anti-replay window is greater than the predetermined value in operation S440.

In one example, the first bit map is a 64-bit map having a minimum value is 39 and a maximum value is 102, centered on the maximum value 70 of the sequence number of the current anti-replay window. The second bit map is a 64-bit map having a minimum value of 119 and a maximum value of 182, centered on the sequence number 150 of the packet. When the first bit map and the second bit map are created, the bit value of the maximum value 70 of the current anti-replay window and the bit value of the sequence number 150 of the extracted packet are set to “1” in the first bit map and second bit map, respectively.

Next, the receiving host receives a packet having a sequence number 151. Since the sequence number 151 of the received packet is included in the second bit map, the bit value for the sequence number 151 of the second bit map is set to “1”. Then, the receiving host receives a packet having a sequence number 153. Since the sequence number 153 of the received packet is included in the second bit map, the bit value for the sequence number 153 is set to “1”.

The operation described above is performed during a predetermined time using a timer. If the operation of the timer is exceeded when the packet having a sequence number 153 is received, the number of 1-bit values in the first bit map is compared with the number of 1-bit values in the second bit map. Since the number of 1-bit values in the first bit map is 1 and the number of 1-bit values in the second bit map is 3, the anti-replay window is updated based on the second bit map. The anti-replay window is updated using the sequence number 153, which is the maximum value of the sequence numbers having a bit value of “1” in the second bit map, as the maximum value of the sequence number of the anti-replay window.

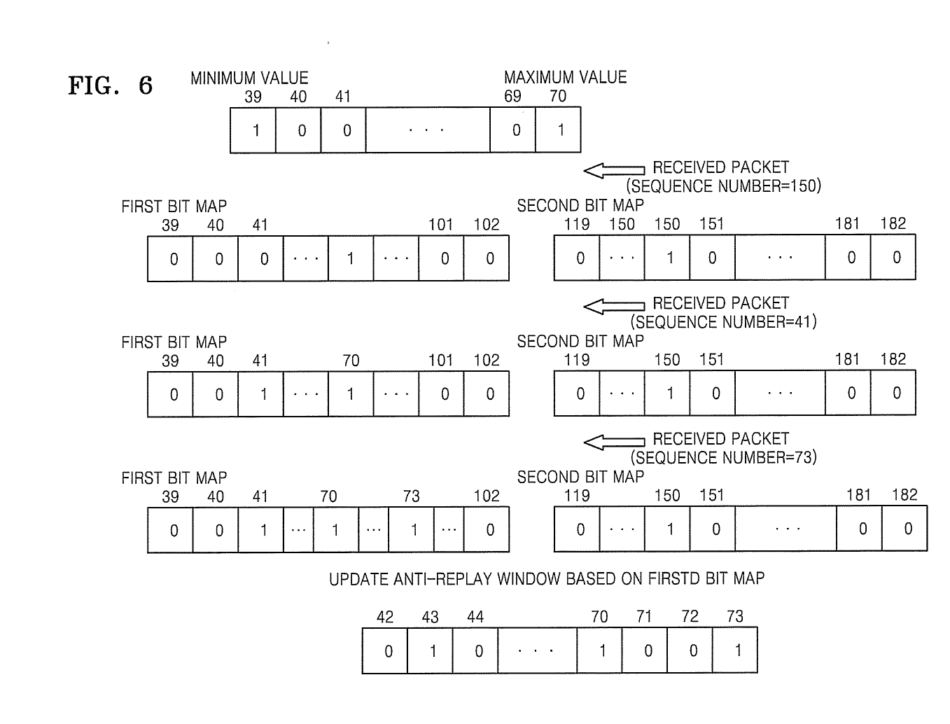

FIG. 6 shows another example of the anti-replay window updating process shown in FIGS. 4A and 4B, according to an embodiment of the present invention. Referring to FIG. 6, the current anti-replay window is composed of a 32-bit map in which the minimum value of the sequence number is 39 and the maximum value of the sequence number is 70.

First, the receiving host receives a packet having a sequence number 150. The sequence number 150 of the received packet is greater than the maximum value of the sequence number of the anti-replay window, and it is assumed that a difference of 80 between the sequence number 150 of the extracted packet and the maximum value 70 of the sequence numbers of the anti-replay window is greater than a predetermined value

In this example, the first bit map is a 64-bit map having a minimum value of 39 and a maximum value of 102, centered on the maximum value 70 of the current anti-replay window. The second bit map is a 64-bit map having a minimum value of 119 and a maximum value of 182, centered on the sequence number 150 of the packet. When the first bit map and the second bit map are created, the bit value of the maximum value 70 of the current anti-replay window and the bit value of the sequence number 150 of the packet are set to “1”.

Next, the receiving host receives a packet having a sequence number 41. Since the sequence number 41 of the received packet is included in the first bit map, the bit value for the sequence number 41 of the first bit map is set to “1”. Then, the receiving host receives a packet having a sequence number 73. Since the sequence number 73 of the received packet is included in the first bit map, the bit value for the sequence number 73 of the first bit map is set to “1”.

The operation described above is performed during a predetermined time using a timer. If the operation of the timer is exceeded when the packet having the sequence number 73 is received, the number of 1-bit values in the first bit map is compared with the number of 1-bit values in the second bit map. Since the number of 1-the bit values in the first bit map is 3 and the number of 1-bit values in the second bit map is 1, the anti-replay window is updated based on the first bit map. The anti-replay window is updated using the sequence number 73, which is the maximum value of the sequence number having a 1-bit value in the first bit map, as the maximum value of the sequence number of the anti-replay window.

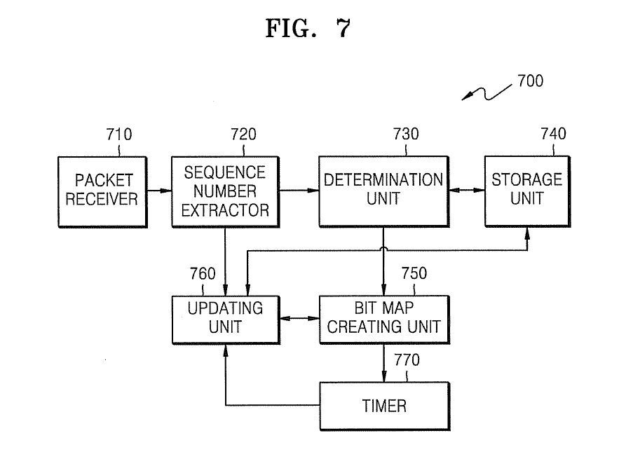

FIG. 7 shows an apparatus for updating an anti-replay window in IPSec, according to an embodiment of the present invention. The apparatus includes a packet receiver 710, a sequence number extractor 720, a determination unit 730, a storage unit 740, a bit map creating unit 750, an updating unit 760, and a timer 770. According to other aspects of the present invention, the apparatus may include additional and/or different units. Similarly, the functionality of two or more of the above units may be integrated into a single unit.

The packet receiver 710 receives a packet transmitted from a transmitting host. The sequence number extractor 720 extracts a sequence number of the packet received from the packet receiver 710. The storage unit 740 stores a current anti-replay window.

The determination unit 730 determines whether a difference between the sequence number extracted by the sequence number extractor 720 and the maximum value of sequence numbers of the anti-replay window stored in the storage unit 740 is greater than a predetermined value. For example, the predetermined value may be set to a value obtained by subtracting the minimum value of the sequence numbers of the anti-replay window from the maximum value of the sequence numbers. Furthermore, the predetermined value may be set according to system type.

If the determination unit 730 determines that the difference between the extracted sequence number and the maximum value of the sequence number of the anti-replay window is greater than the predetermined value, the bit map creating unit 740 creates a first bit map based on the size of the anti-replay window and a second bit map based on the sequence number extracted by the received packet, respectively. The first bit map may include the entire current anti-replay window and may be larger than the maximum value of the sequence number of the current anti-replay window by a predetermined size. For example, the first bit map may be double the size of the current anti-replay window. The second bit map may have a sequence number of the packet extracted by the sequence number extractor 720, as an intermediate value, and may be of the same size as the first bit map.

The updating unit 760 compares the number of bit values of packets received during a predetermined time in the respective first and second bit maps created by the bit map creating unit 740, and updates the anti-replay window. The updating unit 760 compares the number of 1-bit values in the first bit map with the number of 1-bit values in the second bit map during a predetermined time, and updates the anti-replay window based on the bit map having the most number of 1-bit values.

If the number of the 1-bit values of the first bit map is more than the number of 1-bit values of the second bit map, the updating unit 760 updates the anti-replay window using the maximum value of the sequence number having a bit value of “1” in the first bit map as the maximum value of the sequence number of the anti-replay window. If the number of 1-bit values of the second bit map is more than the number of 1-bit values of the first bit map, the updating unit 760 updates the anti-replay window using the maximum value of the sequence number having a bit value “1” in the second bit map as the maximum value of the sequence number of the anti-replay window. If the sequence number extracted from the received packet is smaller than the minimum value of the sequence numbers of the anti-replay window, the updating unit 760 discards the received packet. The timer 770 begins to operate when a bit map creating signal is received from the bit map creating unit 750, and allows the updating unit 760 to compare the number of bit values of the received packets in the first bit map with the number of bit values of the received packets in the second bit map only during a predetermined time.

Parts not described in FIG. 7 can be referred to as shown in FIG. 4 through FIG. 6.

Aspects of the present invention may be embodied as computer readable codes on a computer readable recording medium. The computer readable recording medium may be any data storage device that can store data which can be thereafter read by a computer system. Examples of the computer readable recording medium include read-only memory (ROM), random-access memory (RAM), CDs, DVDs, magnetic tapes, floppy disks, and optical data storage devices. Additional aspects of the present invention may be embodied as carrier waves (such as data transmission through the Internet). The computer readable recording medium can also be distributed over network coupled computer systems so that the computer readable code is stored and executed in a distributed fashion.

In the method and apparatus for updating an anti-replay window in IPSec, according to aspects of the present invention, since a temporary packet replay attack by an arbitrary third party can be avoided and the anti-replay window can be flexibly updated according to a network environment, it is possible to significantly reduce the loss of received packets. A problem exists in a conventional method of increasing the anti-replay window without a separate checking process and a transmitted packet may not be received appropriately from a transmitting host. However, since aspects of the present invention update the anti-replay window according to the reception status of packets during a predetermined period after receiving a packet including a great sequence number temporarily, the above problem can be resolved.

When a packet's transmission path is significantly shortened or routing time is reduced due to a change in a network environment, an appropriate packet transmitted by the other host may be received first. Conventionally, a problem exists that when a sequence number of receiving packet greatly exceeds the range of an anti-replay window, a packet is discarded and an appropriate packet transmitted from a transmitting host cannot be received. Since aspects of the present invention update the anti-replay window according to the reception status of packets during a predetermined time after receiving a packet including a large sequence number, the above problem can be resolved.

Although a few embodiments of the present invention have been shown and described, it would be appreciated by those skilled in the art that changes may be made in this embodiment without departing from the principles and spirit of the invention, the scope of which is defined in the claims and their equivalents.

1. A method of updating an anti-replay window in IPSec (Internet Protocol Security), comprising:
determining whether a difference between a sequence number extracted from a received packet and a maximum value of a sequence number of an anti-replay window is greater than a predetermined value;
if the difference is greater than the predetermined value, creating a first bit map based on a size of the anti-replay window and a second bit map based on the sequence number extracted from the received packet, respectively; and
comparing the number of bit values in the first bit map of packets received during a predetermined time with the number of bit values in the second bit map of the packets received during the predetermined time; and
updating the anti-replay window based on the result of the comparison.

2. The method of claim 1, wherein the predetermined value is obtained by subtracting a minimum value of the sequence number of the anti-replay window from the maximum value of the sequence number of the anti-replay window.

3. The method of claim 1, wherein the predetermined time is measured using a timer operating after creating the first bit map and the second bit map.

4. The method of claim 1, wherein the first bit map comprises the anti-replay window and is larger than the maximum value of the sequence number of the anti-replay window by a predetermined amount.

5. The method of claim 4, wherein the first bit map is double the size of the anti-replay window.

6. The method of claim 4, wherein the second bit map has the sequence number extracted from the received packet as an intermediate value, and has the same size as the first bit map.

7. The method of claim 1, wherein bit values of the packets respectively received are set to “1” in the first and second bit maps.

8. The method of claim 7, wherein:
the comparing of the bit values comprises comparing the number of 1-bit values in the first bit map with the number of 1-bit values in the second bit map during the predetermined time; and
the updating of the anti-replay window comprises updating the anti-replay window based on the bit map having the most 1-bit values.

9. The method of claim 8, wherein the updating of the anti-replay value window comprises updating the anti-replay window using the maximum value of the sequence number of the first bit map comprising the 1-bit values as the maximum value of the sequence number of the anti-replay window, if the number of 1-bit values in the first bit map is more than the number of 1-bit values in the second bit map.

10. The method of claim 8, wherein, if the number of 1-bit values in the second bit map is more than the number of 1-bit values in the first bit map, the updating of the anti-replay window comprises updating the anti-replay window using the maximum value of the sequence number of the second bit map comprising 1-bit values as the maximum value of the sequence number of the anti-replay window.

11. The method of claim 1, further comprising:
updating the anti-replay window, using the sequence number extracted from the received packet as the maximum value of the sequence number of the anti-replay window, if the difference is not greater than the predetermined value and the sequence number extracted from the received packet is greater than the maximum value of the sequence number of the anti-replay window.

12. The method of claim 1, further comprising:
discarding the received packet if the difference is not greater than the predetermined value and the sequence number extracted from the received packet is smaller than the minimum value of the sequence number of the anti-replay window.

13. An apparatus to update an anti-replay window in IPSec (Internet Protocol Security), the apparatus comprising:
a determination unit to determine whether a difference between a sequence number extracted from a received packet and a maximum value of a sequence number of the anti-replay window is greater than a predetermined value;
a bit map creating unit to create a first bit map based on a size of the anti-replay window and a second bit map based on the sequence number extracted from the received packet, respectively, if the difference is greater than the predetermined value; and
an updating unit to compare the number of bit values in the first bit map of packets received during a predetermined time with the number of bit values in the second bit map of the packets received during a predetermined time, and to update the anti-replay window based on the result of the comparison.

14. The apparatus of claim 13, wherein the predetermined value is obtained by subtracting a minimum value of the sequence number of the anti-replay window from the maximum value of the sequence number.

15. The apparatus of claim 13, wherein the predetermined time is measured through a timer operating after creating the first bit map and the second bit map.

16. The apparatus of claim 13, wherein the first bit map includes the anti-replay window and is larger than the maximum value of the sequence numbers of the anti-replay window by a predetermined size.

17. The apparatus of claim 16, wherein the second bit map has the sequence number extracted from the received packet as an intermediate value, and has the same size as the first bit map.

18. The apparatus of claim 13, wherein bit values of the packets respectively received are set to “1” in the first and second bit maps.

19. The apparatus of claim 18, wherein the updating unit compares the number of 1-bit values in the first bit map with the number of 1-bit values in the second bit map during the predetermined time, and updates the anti-replay window based on the bit map having the most 1-bit values.

20. The apparatus of claim 13, wherein, if the determination unit determines that the difference is not greater than the predetermined value and the sequence number extracted from the received packet is less than the minimum value of the sequence numbers of the anti-replay window, the updating unit discards the received packet.

21. A computer-readable recording medium storing a computer program to execute the method of claim 1.

22. A method of updating an anti-replay window in Internet Protocol Security (IPSec), the method comprising:
receiving a packet;
if a difference between a sequence number of the packet and a maximum value of an anti-replay window is greater than a predetermined value, creating a first bit map based on a size of the anti-replay window and a second bit map based on the sequence number; and
updating the anti-replay window based on the first bit map or the second bit map.

23. The method according to claim 22, wherein:
the updating of the anti-replay window comprises updating the anti-replay window based on the first bit map if a number of bit values of “1” in the first bit map is greater than a number of bit values of “1” in the second bit map; and
the updating of the anti-replay window comprises updating the anti-replay window based on the second bit map if the number of bit values of “1” in the second bit map is greater than or equal to the number of bit values of “1” in the first bit map.

24. The method according to claim 22, further comprising:
for a predetermined period of time prior to updating the anti-replay window, changing a bit value of the first map to “1” if a packet received during the predetermined period has a sequence number corresponding to the bit value of the first map, and changing a bit value of the second map to “1” if the packet received during the predetermined period has a sequence number corresponding to the bit value of the second map.

25. The method according to claim 24, wherein the predetermined period of time is determined based on a communication characteristic.

26. An apparatus to perform Internet Protocol Security (IPSec) using an anti-replay window according to a status of sequence numbers of received packets, the apparatus comprising:
a packet receiver to receive packets;
a bit map creating unit to create a first bit map based on a size of the anti-replay window and a second bit map based on a sequence number of a packet received by the packet receiver, if a difference between the sequence number and a maximum value of the anti-replay window is greater than a predetermined value; and
an updating unit to update the anti-replay window based on the first bit map or the second bit map.

27. The apparatus according to claim 26, further comprising:
a determination unit to determine whether the difference between the sequence number and the maximum value of the anti-replay window is greater than the predetermined value.

28. The apparatus according to claim 26, further comprising:
a storage unit to store the first bit map and the second bit map.

29. The apparatus according to claim 26, wherein, for a predetermined period of time prior to updating the anti-replay window, the updating unit changes a bit value of the first map from to “1” if a packet received during the predetermined period has a sequence number corresponding to the bit value of the first map, and changes a bit value of the second map to “1” if the packet received during the predetermined period has a sequence number corresponding to the bit value of the second map.

30. The apparatus according to claim 29, wherein:
the updating unit updates the anti-replay window using the first bit map if a number of bit values of “1” in the first bit map is greater than a number of bit values of “1” in the second bit map; and
the updating unit updates the anti-replay window using the second bit map if the number of bit values of “1” in the second bit map is greater than or equal to the number of bit values of “1” in the first bit map.

31. The apparatus according to claim 29, further comprising:
a timer to determine when the predetermine time period begins and ends.
